(19) United States
(12) Patent Application Publication
(10) Pub. No.: US 2003/0005617 A1
(43) Pub. Date: Jan. 9, 2003

(54) Bait container

(76) Inventor: Clyde A. Holverson JR., Platteville, WI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/102,005

(22) Filed: Mar. 20, 2002

Related U.S. Application Data
(60) Provisional application No. 60/303,130, filed on Jul. 5, 2001.

(51) Int. Cl. B65D 41/18; A01K 97/04; B65D 51/00

(52) U.S. Cl. 43/41; 220/916; 220/793

(57) ABSTRACT

A live bait container for earthworms and the like includes a cylindrical housing with open ends, a cover for each end and aeration provisions in the central portion of the housing between the two ends. The configuration permits the bedding to fall to the bottom and the bait will generally seek the cool and moist bedding at the very bottom. To extract bait the container is inverted and the upper cover removed. The bedding has fallen to the bottom of the container and the earthworms are exposed at the top of the bedding in a very convenient and facile manner.

### REFERENCE TO RELATED PATENT APPLICATION

This patent application is based on and claims the benefits of U.S. Provisional Application No. 60/303,130, filed on Jul. 5, 2001

### FIELD OF THE INVENTION

This invention pertains to storing and handling fishing bait and more particularly to bait containers that provide easy loading with bait and bedding and easy access to the live bait such as earthworms. The container provides a moist medium and favorable environment during storage, transport and use.

### BACKGROUND OF THE INVENTION

Fishing is an ancient endeavor providing both a healthy food source and entertainment. Fishing frequently involves the use of live bait and in particular earthworms or the like. It is generally recognized that earthworms survive best in a moist bedding or medium preferably soil (ground or earth) with the nutrients and moisture contained therein. By their very nature, earthworms seek darkness and a cool environment and thus frequently, when restrained in a container having an earth medium, seek the bottom of the container for darkness and cool temperatures.

Those bedding conditions and one package for meeting those conditions for earthworms or other light sensitive worms are discussed in U.S. Pat. No. 4,172,336. That patent discloses a relatively complex layered package construction fabricated from corrugated cardboard or the like. Such a package will provide containment for earthworms for shipping and/or storage but is not well adapted for use by the fishermen at a fishing location.

One effort to store and nurture earthworms while making them readily available to the fishermen at a fishing site is the worm cradle bait box of U.S. Pat. No. 4,819,867. The worm cradle is a one-piece molded rectangular construction with one side cut away to provide access to the earthworms by the fisherman. It has no permanent lid. The patent teaches a simple 90° rotation of the box for the purposes of upsetting the contents of the box and hopefully having the earthworms exposed at the single open corner. Such an arrangement does not provide a repositioning that optimizes the exposure of earthworms on top of the soil or other medium and is quite inconvenient for handling, especially in an environment at a fishing site.

Another approach to a live bait storage container is shown and described in U.S. Pat. No. 4,882,872. The container is an open-topped box designed to receive a live bait storage medium and bait such as earthworms. The box has a hinged cover. The cover holds a sponge to be soaked with water. The box can be stored upside down and the sponge keeps the storage medium moist. The patent points out that the worms usually travel to the cool, moist lowest point in a container and thus by storage on the sponge and inversion before opening the cover, the earthworms will be more readily accessible on top. The bait containers known in the prior art have been cumbersome and costly and have failed to provide an inexpensive, very portable storage device which provides easy access to earthworms and the like at the fishing site.

### BRIEF SUMMARY OF THE INVENTION

The bait container of this invention provides storage for earthworms or the like in a moist medium such as soil or bedding, provides aeration for the bait and medium, and makes the bait readily available near the top surface of the medium by simple manipulation and easy access to the contents of the container. The improved bait storage container includes a hollow cylindrical or tubular housing having a longitudinal axis and first and second edges defining openings at the respective ends. A cover is provided for each end having a central portion conforming to and closing the openings. In using the term “hollow cylindrical housing,” that term is intended to include any structure having two longitudinally spaced open ends and a smooth inner wall connecting those open ends which will permit soil or bedding medium to slide from one open end to the other when the housing is inverted. The cover provided at each opening forms a seal with the edge of the opening but is in releasable engagement with the edge of the housing surrounding the opening. Aeration apertures are provided generally in the central portion of the housing, the apertures being of a size that will permit the ingress and egress of moist air without passing any significant portion of the soil or other bedding contained within the housing when the bait storage container is in use.

### BRIEF DESCRIPTION OF THE DRAWINGS

The foregoing and other objects and features of the invention will be understood from the following description taken in connection with the accompanying drawings in which:

FIG. 1 illustrates a sectional elevation view of one embodiment of the invention in a first operative position;

FIG. 2 shows the embodiment of FIG. 1 inverted with the upper cover ajar and the bedding material and bait shifted to the lower end.

FIG. 3 is a fragmentary illustration of an alternate embodiment of the bait container of this invention;

FIG. 4 is a fragmentary view of another alternate embodiment of the housing and cover of the invention;

FIG. 5 is a fragmentary view of an alternate housing configuration in accordance with the invention;

FIG. 6 shows an additional embodiment of the invention with a cover restraint feature;

FIG. 7 shows still an additional embodiment of the invention with an alternate cover restraint feature; and

FIG. 8 is a fragmentary view of the housing and cover of FIG. 7 illustrating the restraint feature and its operation.

### DETAILED DESCRIPTION OF THE INVENTION

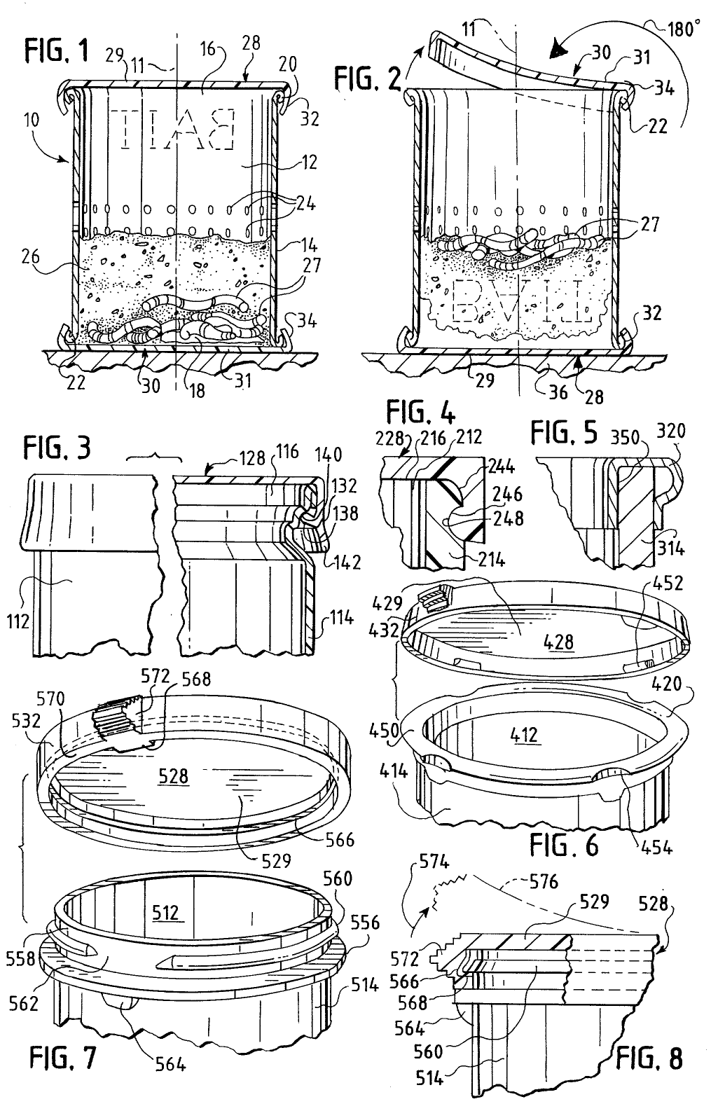

Referring now to the drawings and more particular to FIG. 1, a bait container 10 is illustrated in an elevational cross section wherein the housing 12 has a cylindrical wall 14 having open ends 16 and 18. The wall 14 in the embodiment of FIG. 1 is formed of thin metal such as tin plated steel and has a bead 20 adjacent the open end 16 and a similar bead 22 adjacent the open end 18. The wall 14 is provided with a plurality of apertures 24 located in the central area between the open ends 16 and 18. The size of the apertures 24 is selected to permit aeration of the contents of the bait container 10 while substantially preventing the egress of bedding material or bait from within the housing.

FIG. 1 shows a representative bedding material 26 disposed in the lower portion of the container 10 and below the level of the aeration apertures 24. The housing has a longitudinal axis 11 and the surface configuration of housing 12 is such that sliding of the bedding 26 is facilitated. The bedding 26 may be of any appropriate material including soil or various bedding materials commercially available to fishermen. Earthworms 27 are schematically indicated in the bedding material 26. The configuration of the mass including the bedding material 26 and earthworms 27 within the housing 12 is typical, that is, earthworms characteristically seek the coolest and most moist environment that is available and typically that environment is at the bottom of a bait container configured in the manner of FIG. 1.

As shown in FIGS. 1 and 2 appropriate indicia indicating the nature of the product, a trademark, the manufacturer and other data can be printed on the external surface of housing 14 as well as the housings of the other embodiments. The legend “BAIT” shown in FIG. 1 is inverted when the container 10 is inverted in FIG. 2 to exemplify the inversion process and repositioning the bedding and bait. If desired, the aeration apertures 24 can be designed to convey information as, for example, a series of apertures spelling out the word “BAIT”.

As shown in FIG. 1, the open ends 16 and 18 of the housing 12 are closed by covers 28 and 30. In the embodiment of FIG. 1, the covers 28 and 30 are molded of an appropriate copolymer. They have relatively thin central portions 29 and 31 closing the end openings of housing 12 and integrally formed lips 32 and 34 respectively. The material of the covers 28 and 30 and the dimensions and configurations of the lips 32 and 34 are selected to provide resilience in the lips so that they can be urged over the beads 20 and 22 and retained in that position with a substantial margin of safe securement. On the other hand, the lips 32 and 34 are sufficiently flexible and the material of sufficient tensile strength to permit repeated application of the covers to the respective ends of the housing 12, yieldable retention of the covers on the housing and removal therefrom for access to the cavity within the housing 12. The lips 32 and 34 may include annular rings on the inner surfaces displaced from the central portions 29 and 31 to enhance retention against beads 20 and 22.

The cross sectional area defined by the wall 14 may vary in size and in specific configuration. The terms “cylinder” and “cylindrical” are used in this description to define a cavity in which the contents such as the bedding and earthworms shown in FIG. 1 can readily slide from adjacent the lower cover 30 as shown in FIG. 1 to the new lower position on cover 28 shown in FIG. 2 when the bait container 10 is inverted. In general, the wall 14 can be any surface traced by a straight line moving parallel to a fixed straight line such as line 11 about a closed path. The body or cavity defined by that surface and two planes transverse to the axis 11 may comprise a right circular cylinder as shown in the drawings. On the other hand, the bait container may have an oval or other smoothly curved cross section or may be square, octagonal or the like. Moreover, slight discontinuities such as strengthening rings may be included that do not interfere with bedding movement upon inversion. The right circular construction shown in the figures is the preferred embodiment. The capacity of the bait container 10 will obviously depend upon the size of the component parts and the particular market that the bait container is serving. For the casual fisherman or for a relatively brief fishing event, a housing several inches in height and several inches in diameter may well be adequate to provide a moist and cool environment for an adequate supply of earthworm bait. In one preferred embodiment the housing 12 has a four inch diameter. On the other hand, for a more extensive fishing occasion, larger size housings will be preferred.

The configuration shown in FIG. 1 has been found to permit easy access to the contents of the container 10 including the ability to remove the lower cover 30 in a manner shown in FIG. 2 with the container in an inverted position. The cover 30 can be removed with one hand while the container is resting on an appropriate surface 36.

If a more tenacious attachment of the covers to the housing is desired, the embodiment of FIGS. 3-8 are appropriate. The embodiment of FIG. 3 includes a housing 112 and a pair of covers illustrated by cover 128. In the embodiment of FIG. 3, the cover lip 132 is configured with an inwardly directed flange 138. The lip 132 may extend axially a greater distance than the lip 32 of FIG. 1 so that the flange 138 can better engage a bead such as bead 20 shown in FIG. 1. If desired, the portion of the wall 114 adjacent the end 116 may have a peripheral recess 140 to more positively receive the flange 138. In the embodiment of FIG. 3 with the enhanced retaining forces provided by flange 138 in recess 140, the lip 132 has an extending flare 142 which facilitates removal of the cover 128 from the housing 112.

FIG. 4 illustrates a small fragment of a housing 212 having a wall 214 formed of a copolymer with the necessary rigidity to maintain its shape and outer configuration. The wall 214 has a curved edge bead 244 with a recess 246 formed in the outer surface of the wall 214 and displaced from the wall end 216. The cover 228 is also of a molded copolymer and has a inward rib 248 which cooperates with the recess 246 to releasably retain the cover in place on the housing 212. A tab or flare like flare 142 in FIG. 3, not shown in FIG. 4, can extend axially downward from the central portion of the cover to assist in removal of the cover from the housing 212.

FIG. 5 shows a fragment of another housing wall 314 formed of a rolled foil coated fiber sheet with a metal ring 350 crimped on the edge of the wall 314. Wall 314 has a bead 320 formed outwardly for retention of a cover (not shown). The cover 28 described with respect to FIGS. 1 and 2 can be adapted for the housing of FIG. 5 or, in the alternative, a cover configuration like the cover 128 of FIG. 3 can be similarly adapted to the coated fiberboard housing 312 with the metal ring 350.

The bait container embodiment of FIG. 6 is similar to the container already described with respect to FIGS. 1 and 2 and FIG. 5. In the bait container of FIG. 6, a more positive system is provided for locking and releasing the cover 428. The wall 414 may have an all-metal wall like the housing 12 of FIGS. 1 and 2 or it may be of a copolymer (FIG. 4). It may also have a coated fireboard construction such as wall 314 with a metallic ring 450 like the ring 350 of FIG. 5. The cover 428 has a lip 432 like the lip 32 of FIGS. 1 and 2. However, the shape of the lip is modified to include a configuration to hold the cover 428 on the housing 412 with less resistance to removal than that described above with respect to FIGS. 1 and 2. The inner surface of lip 432 has been modified to provide locking by adding four small tabs 452 disposed in quadrature about the inside surface of lip 432 and extending radially inwardly but spaced axially from the central cover portion to form a part of the locking system. The ring 450 secured to the edge of wall 414 has been modified in a matching pattern with four notches 454. Notches 454 are in quadrature and sized to permit the tabs 452 to pass to a position longitudinally beyond the ring 450 when the cover is applied and to pass through notches 454 when the cover is removed. By rotating the cover 428 when it is placed on the ring 450 so that the tabs 452 are out of alignment with the notches 454, the cover is firmly locked on the housing 414 to prevent unintended or accidental removal of the cover from the housing. With the locking system of the embodiment of FIG. 6, the tenacity with which the lip 432 grips the bead 420 is reduced, making intentional removal of one cover much easier when it is the upper cover and the notches and tabs are aligned.

The embodiment of FIGS. 7 and 8 is also configured to facilitate easier removal of the cover 528 from the housing 512 when desired for access to the chamber and the earthworm bait therein while precluding inadvertent disconnection. The locking system provided in the embodiment of FIGS. 7 and 8 is similar to the system of FIG. 6 but especially adapted to a bait container including both a cover and housing formed of a copolymer or other moldable material. The cover retention system of the embodiment of FIGS. 7 and 8 is similar to systems used in childproof medication packaging and the like. The molded plastic housing 512 has a wall 514 with a flange 556 and a wall portion 558 thereabove. A discontinuous bead 560 is integrally molded in the upper wall 558 and includes a discontinuity 562 conforming to the surface shape of the remainder of the upper wall 558. An identifier 564 is molded under the flange 556 to identify the location of the discontinuity 562 when the cover 528 is in place concealing the upper wall 558 and the position of discontinuity 562.

The cover 528 includes a lip 532 and a central cover portion 529. On the inside surface of lip 532 a slight circular recess 566 is formed and positioned to align with the discontinuous bead 560 when the cover is in place on the wall 514. A tab 568 is formed on the inner surface of lip 532 between the annular recess 566 and the distal edge 570 of the lip 532. Opposite the tab 568 and on the outer surface of lip 532 there is a gripping tab and indicator 572 to indicate the location of the locking tab and to facilitate removal of the cover 528 from the housing 512. The locking tab 568 and the lift tab 572 are shown in the cutaway portion of the cover 528 in FIG. 8.

The operative relationship of the bead 560 of wall 514 and the recess 566 in the cover lip 532 can be seen clearly in FIG. 8. When the discontinuity 562 of flange 560 is aligned with the locking tab 568 of lip 532, only the engagement of flange 560 in the recess 566 resists the removal of the cover 528 from the wall 514. The removal motion is indicated by arrow 574 and the position shown by broken lines 576. The peeling action of the cover illustrated by arrow 574 and broken lines 576 is made possible by the manipulation of lifting tab 572 and the alignment of locking tab 568 with discontinuity 562. By rotating the cover 528 about the housing 512 to place the locking tab 568 out of alignment with the discontinuity 562, the peeling action described above is impossible. Thus the cover is securely maintained on the housing 512 when that cover is the bottom cover of the bait container, as in the position of rest on surface 36 shown in FIG. 2. When the container is in the position shown in FIG. 1 with the cover 528 uppermost, the bedding and bait will be in the bottom resting on the oppositely disposed cover. In that position, when the indicator tabs 564 and 572 are aligned, the cover 528 can be readily removed.

It should be understood, of course, that only one cover and the relationship of that cover to the housing and its components is described in detail. In all cases, including the embodiments of FIGS. 3-8, the details illustrated and described with respect to FIGS. 1 and 2 are applied at both ends and the same results are obtained.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein.

Preferred embodiments of this invention are described herein, including the best modes known to the inventor for carrying out the invention. Of course, variations of those preferred embodiments will become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A container for the storage of live bait comprising:
a hollow cylindrical housing having a longitudinal axis, a first edge defining an opening at a first end and a second edge defining an opening at a second end;
a first cover having a central portion conforming to and closing the opening at said first end;
a second cover having a central portion conforming to and closing the opening at said second end; and
at least one aeration aperture in said housing centrally located between said openings;
said first cover having a closure portion thereof in sealed but releasable engagement with said housing adjacent said first edge and said second cover having a closure portion thereof in sealed but releasable engagement with said housing adjacent said second edge.

2. The container of claim 1 wherein said housing includes a first portion defining a bead along said first edge and a second portion defining a bead along said second edge, said beads cooperating with the respective closure portions of said first cover and said second cover.

3. The container of claim 2 wherein said closure portions of said first cover and said second cover each comprise a resilient lip extending from said central portion which overlies and is releasably retained by said first and said second bead, respectively.

4. The container of claim 3 wherein said first and second covers are of a resilient copolymer.

5. The container of claim 3 wherein said housing and beads are formed of sheet metal.

6. The container of claim 3 wherein said housing is a right circular cylinder, said first bead and said second bead include a peripheral discontinuity and the lip of said first cover and of said second cover include a radial projection which inhibits removal of the cover from the housing when in a position other than alignment with the respective discontinuity.

7. The container of claim 4 wherein said housing and said beads are of a copolymer relatively rigid compared to said cover.

8. The container of claim 3 wherein said housing is formed of a fibrous material with a moisture proof surface coating and said first and second beads are secured at the respective ends thereof.

9. The container of claim 7 wherein said housing includes a first locking ring that is spaced from said first edge and includes a discontinuity and a second locking ring that is spaced from said second edge and includes a discontinuity, said first cover and said second cover each having an inward tab portion axially spaced from the respective lip to engage the respective locking ring of said housing in rotational positions other than alignment with said ring discontinuity.

10. A container for the storage of live bait comprising:
a hollow cylindrical housing having a longitudinal axis, a first edge defining an opening at a first end and a second edge defining an opening at a second end;
a first cover having a central portion conforming to and closing the opening at said first end;
a second cover having a central portion conforming to and closing the opening at said second end;
at least one aeration aperture in said housing centrally located between said openings; and,
friable bedding for earthworms in an amount not exceeding the space between one of said covers and said aperture;
said first cover having a closure portion thereof in sealed but releasable engagement with said housing adjacent said first edge and said second cover having a closure portion thereof in sealed but releasable engagement with said housing adjacent said second edge.
